(19) United States
(12) Patent Application Publication
(10) Pub. No.: US 2025/0150956 A1
(43) Pub. Date: May 8, 2025

(54) PROVIDING TEMPORARY NETWORK SLICE SERVICES IN A COMMUNICATION SYSTEM

(71) Applicant: Nokia Technologies Oy, Espoo (FI)

(72) Inventors: Ömer BULAKCI, Munich (DE); Rajesh Babu NATARAJAN, Bangalore (IN); Sung Hwan WON, Dallas, TX (US); Philippe GODIN, Massy (FR); Halit Murat GÜRSU, Munich (DE); Muhammad NASEER-UL-ISLAM, Munich (DE); Alessio CASATI, West Molesey (GB)

(21) Appl. No.: 18/960,920

(22) Filed: Nov. 26, 2024

Related U.S. Application Data
(63) Continuation of application No. 18/684,920, filed on Feb. 20, 2024.

(51) Int. Cl. H04W 48/18; H04W 76/38

(52) U.S. Cl. CPC H04W 48/18; H04W 76/38

(57) ABSTRACT

According to the disclosure there is provided an apparatus. The apparatus comprises means for performing: receiving first information of a network slice that is to be made available to the apparatus on a temporary basis, the first information comprising an identifier of the network slice; and receiving second information of the network slice, the second information comprising timing information of the network slice, indicating it's available period after expiry of which its removed from the allowed network slices list without any explicit signalling.

### CROSS REFERENCE TO RELATED APPLICATIONS

This application is a continuation of U.S. patent application Ser. No. 18/684,920, filed on Feb. 20, 2024, which is a national stage application, filed under 35 U.S.C. § 371, of International Patent Application No. PCT/EP2021/073123, filed on Aug. 20, 2021, both of which are incorporated herein in their entirety.

### FIELD

The present disclosure relates to methods, apparatuses and computer program products for providing services in a communication system, and more particularly but not exclusively to network slicing.

### BACKGROUND

A communication system provides a communication facility between two or more devices such as user terminals, machine-like terminals, base stations and other access points, network functions, service producers, service consumers, and/or other devices. A communication system can be provided for example by means of a communication network and one or more compatible devices providing communication channels for carrying information between the communicating devices. Communication sessions may comprise, for example, communication of data for carrying communications for services such as voice, video, electronic mail (email), text message, multimedia, control data and/or content data and so on.

The communication system, services, functions and devices typically operate in accordance with a given standard or specification which sets out what the various entities associated with the system are permitted to do and how that should be achieved. Communication protocols and/or parameters which shall be used for the connection are also typically defined. Non-limiting examples of communication systems include those based on fifth generation (5G) networks standardized by the 3rd Generation Partnership Project (3GPP).

A feature of modern communication systems is known as network slicing. Network slicing is a feature that enables multiplexing of virtualized and/or independent logical networks on a physical network infrastructure. A sliced network can comprise a set of logical networks on top of a shared infrastructure. Each logical network is designed to serve a defined purpose and comprises all required network resources, configured and connected end-to-end. Each network slice can be understood as an isolated end-to-end network tailored to fulfil diverse requirements requested by a particular application. Flexible and scalable network slices can be provided on top of a common network infrastructure. Each network slice can be administered by a network operator. Further, a network slice of one operator can be offered to another operator to build another network slice. Operators can define the specific characteristics of a slice, for example speed, latency, reliability, and security. Different slices can be required by different functions. For example, some services require a low latency and very reliable slice whereas others may require higher bandwidth but would have less need for low latency.

### SUMMARY

According to a first aspect there is provided an apparatus comprising means for performing receiving first information of a network slice that is to be made available to the apparatus on a temporary basis, the first information comprising an identifier of the network slice; and receiving second information of the network slice, the second information comprising timing information of the network slice.

According to some examples, the first information is received separately from the second information.

According to some examples, the first information is received together with the second information.

According to some examples, the means are further configured to perform accessing the network slice in accordance with the timing information

According to some examples, the first information comprises single network slice selection assistance information.

According to some examples, the timing information comprises a validity timer of the network slice.

According to some examples, the validity timer is in the form of one or more of: an absolute time interval; a time interval relative to a reference time; a periodic time interval.

According to some examples, the means are further configured to receive one or more of: a first validity timer; a second validity timer.

According to some examples, the first validity timer comprises a deployment time of the network slice.

According to some examples, the second validity timer comprises a time for which the apparatus is allowed to use the network slice.

According to some examples, the means are further configured to perform automatically considering the network slice as rejected when the validity timer expires.

According to some examples, the means are further configured to perform moving the network slice to a list of rejected network slices, when the validity timer expires.

According to examples, the means are further configured to perform removing the network slice from the apparatus without signalling to any other nodes.

According to some examples, the means are further configured to perform stopping a packet data unit session when the validity timer expires.

According to some examples, the means are further configured to perform, when the validity timer expires, enabling any ongoing packet data unit sessions associated with the network slice to be completed, but preventing any new packet data unit sessions associated with the temporary network slice from being started.

According to some examples, the apparatus comprises a user equipment.

According to some examples, the means comprises at least one processor; and at least one memory including computer program code, the at least one memory and computer program code configured to, with the at least one processor, cause the performance of the apparatus.

According to a second aspect there is provided an apparatus comprising at least one processor; and at least one memory including computer program code; the at least one memory and the computer program code configured to, with the at least one processor, cause the apparatus at least to perform: receiving first information of a network slice that is to be made available to the apparatus on a temporary basis, the first information comprising an identifier of the network slice; and receiving second information of the network slice, the second information comprising timing information of the network slice.

According to a third aspect there is provided an apparatus comprising: circuitry for receiving first information of a network slice that is to be made available to the apparatus on a temporary basis, the first information comprising an identifier of the network slice; and circuitry for receiving second information of the network slice, the second information comprising timing information of the network slice.

According to a fourth aspect there is provided a method comprising: receiving first information of a network slice that is to be made available to the apparatus on a temporary basis, the first information comprising an identifier of the network slice; and receiving second information of the network slice, the second information comprising timing information of the network slice.

According to some examples the method comprises receiving the first information separately from the second information.

According to some examples the method comprises, receiving the first information together with the second information.

According to some examples the method comprises accessing the network slice in accordance with the timing information.

According to some examples, the first information comprises single network slice selection assistance information.

According to some examples, the timing information comprises a validity timer of the network slice.

According to some examples, the validity timer is in the form of one or more of: an absolute time interval; a time interval relative to a reference time; a periodic time interval.

According to some examples the method further comprises receiving one or more of: a first validity timer; a second validity timer.

According to some examples, the first validity timer comprises a deployment time of the network slice.

According to some examples, the second validity timer comprises a time for which the apparatus is allowed to use the network slice.

According to some examples the method comprises automatically considering the network slice as rejected when the validity timer expires.

According to some examples the method further comprises moving the network slice to a list of rejected network slices, when the validity timer expires.

According to examples the method comprises removing the network slice from the apparatus without signalling to any other nodes.

According to some examples the method comprises stopping a packet data unit session when the validity timer expires.

According to some examples the method further comprises, when the validity timer expires, enabling any ongoing packet data unit sessions associated with the network slice to be completed, but preventing any new packet data unit sessions associated with the temporary network slice from being started.

According to some examples, the method is carried out by an apparatus, wherein the apparatus comprises a user equipment.

According to a fifth aspect there is provided a computer program comprising instructions for causing an apparatus to perform at least the following: receiving first information of a network slice that is to be made available to the apparatus on a temporary basis, the first information comprising an identifier of the network slice; and receiving second information of the network slice, the second information comprising timing information of the network slice.

According to a sixth aspect there is provided a computer program comprising instructions stored thereon for performing at least the following: receiving first information of a network slice that is to be made available to the apparatus on a temporary basis, the first information comprising an identifier of the network slice; and receiving second information of the network slice, the second information comprising timing information of the network slice.

According to a seventh aspect there is provided a non-transitory computer readable medium comprising program instructions for causing an apparatus to perform at least the following: receiving first information of a network slice that is to be made available to the apparatus on a temporary basis, the first information comprising an identifier of the network slice; and receiving second information of the network slice, the second information comprising timing information of the network slice.

According to an eighth aspect there is provided a non-transitory computer readable medium comprising program instructions stored thereon for performing at least the following: receiving first information of a network slice that is to be made available to the apparatus on a temporary basis, the first information comprising an identifier of the network slice; and receiving second information of the network slice, the second information comprising timing information of the network slice.

According to a ninth aspect there is provided an apparatus comprising means for performing, in response to deployment of a temporary network slice that is made available to a user equipment, causing first information to be sent to the user equipment, the first information comprising an identifier of the network slice; and causing second information to be sent to the user equipment, the second information comprising timing information of the network slice; and configuring the apparatus with the first and second information.

According to some examples, the first information comprises single network slice selection assistance information.

According to some examples, the timing information comprises a validity timer of the network slice.

According to some examples, the validity timer is in the form of one or more of: an absolute time interval; a time interval relative to a reference time; a periodic time interval.

According to some examples, the means are further configured to cause sending of one or more of: a first validity timer; a second validity timer.

According to some examples, the first validity timer comprises a deployment time of the network slice.

According to some examples, the second validity timer comprises a time for which the user equipment is allowed to use the network slice.

According to some examples, the means are further configured to perform automatically removing the network slice from the apparatus when the validity timer expires.

According to some examples, the means are further configured to perform moving the network slice to a list of rejected network slices, when the validity timer expires.

According to examples, the means are further configured to perform removing the network slice from the apparatus without signalling to any other nodes.

According to some examples, the means are further configured to perform sending the first information and the second information to a filtered list of user equipment.

According to some examples, the filtered list comprises user equipment having a last known cell identifier belonging to a tracking area where the network slice is deployed.

According to some examples, the apparatus comprises a network apparatus.

According to some examples, the apparatus comprises an access and mobility management function.

According to some examples, the means comprises at least one processor; and at least one memory including computer program code, the at least one memory and computer program code configured to, with the at least one processor, cause the performance of the apparatus.

According to a tenth aspect there is provided an apparatus comprising at least one processor; and at least one memory including computer program code; the at least one memory and the computer program code configured to, with the at least one processor, cause the apparatus at least to perform: in response to deployment of a temporary network slice that is made available to a user equipment, causing first information to be sent to the user equipment, the first information comprising an identifier of the network slice; and causing second information to be sent to the user equipment, the second information comprising timing information of the network slice; and configuring the apparatus with the first and second information.

According to an eleventh aspect there is provided an apparatus comprising: circuitry for, in response to deployment of a temporary network slice that is made available to a user equipment, causing first information to be sent to the user equipment, the first information comprising an identifier of the network slice; and circuitry for causing second information to be sent to the user equipment, the second information comprising timing information of the network slice; and circuitry for configuring the apparatus with the first and second information.

According to a twelfth aspect there is provided a method comprising, in response to deployment of a temporary network slice that is made available to a user equipment, causing first information to be sent from an apparatus to the user equipment, the first information comprising an identifier of the network slice; and causing second information to be sent to the user equipment, the second information comprising timing information of the network slice; and configuring the apparatus with the first and second information.

According to some examples, the first information comprises single network slice selection assistance information.

According to some examples, the timing information comprises a validity timer of the network slice.

According to some examples, the validity timer is in the form of one or more of: an absolute time interval; a time interval relative to a reference time; a periodic time interval.

According to some examples, the method further comprises sending one or more of: a first validity timer; a second validity timer.

According to some examples, the first validity timer comprises a deployment time of the network slice.

According to some examples, the second validity timer comprises a time for which the user equipment is allowed to use the network slice.

According to some examples, the method further comprises automatically removing the network slice from the apparatus when the validity timer expires.

According to some examples, the method further comprises moving the network slice to a list of rejected network slices, when the validity timer expires.

According to examples, the method further comprises removing the network slice from the apparatus without signalling to any other nodes.

According to some examples, the method further comprises sending the first information and the second information to a filtered list of user equipment.

According to some examples, the filtered list comprises user equipment having a last known cell identifier belonging to a tracking area where the network slice is deployed.

According to some examples, the method is performed by an apparatus, wherein the apparatus comprises a network apparatus.

According to some examples, the method is performed by an apparatus, wherein the apparatus further comprises an access and mobility management function.

According to a thirteenth aspect there is provided a computer program comprising instructions for causing an apparatus to perform at least the following: in response to deployment of a temporary network slice that is made available to a user equipment, causing first information to be sent to the user equipment, the first information comprising an identifier of the network slice; and causing second information to be sent to the user equipment, the second information comprising timing information of the network slice; and configuring the apparatus with the first and second information.

According to a fourteenth aspect there is provided a computer program comprising instructions stored thereon for performing at least the following: in response to deployment of a temporary network slice that is made available to a user equipment, causing first information to be sent to the user equipment, the first information comprising an identifier of the network slice; and causing second information to be sent to the user equipment, the second information comprising timing information of the network slice; and configuring the apparatus with the first and second information.

According to a fifteenth aspect there is provided a non-transitory computer readable medium comprising program instructions for causing an apparatus to perform at least the following: in response to deployment of a temporary network slice that is made available to a user equipment, causing first information to be sent to the user equipment, the first information comprising an identifier of the network slice; and causing second information to be sent to the user equipment, the second information comprising timing information of the network slice; and configuring the apparatus with the first and second information.

According to an sixteenth aspect there is provided a non-transitory computer readable medium comprising program instructions stored thereon for performing at least the following: in response to deployment of a temporary network slice that is made available to a user equipment, causing first information to be sent to the user equipment, the first information comprising an identifier of the network slice; and causing second information to be sent to the user equipment, the second information comprising timing information of the network slice; and configuring the apparatus with the first and second information.

According to a seventeenth aspect there is provided an apparatus comprising means for performing: receiving a configuration update, the configuration update comprising information of a temporary network slice and a validity timer of the temporary network slice; and sending the information of the temporary network slice and the validity timer of the temporary network slice to a network node.

According to some examples, the configuration update is received via OAM.

According to some examples the sending the information of the temporary network slice and the validity timer of the temporary network slice to a network node comprises sending to core network via a RAN configuration update procedure or NG setup procedure.

According to some examples, the means are further configured to perform removing the temporary network slice from a list of supported network slices when the validity timer expires.

According to some examples, the means are further configured to perform an update to the validity timer of the temporary network slice prior to the validity timer expiring.

According to some examples, the apparatus comprises a radio access network node, and the network node comprises an access and mobility management function.

According to some examples, the means comprises at least one processor; and at least one memory including computer program code, the at least one memory and computer program code configured to, with the at least one processor, cause the performance of the apparatus.

According to an eighteenth aspect there is provided an apparatus comprising at least one processor; and at least one memory including computer program code; the at least one memory and the computer program code configured to, with the at least one processor, cause the apparatus at least to perform: receiving a configuration update, the configuration update comprising information of a temporary network slice and a validity timer of the temporary network slice; and sending the information of the temporary network slice and the validity timer of the temporary network slice to a network node.

According to a nineteenth aspect there is provided an apparatus comprising: circuitry for receiving a configuration update, the configuration update comprising information of a temporary network slice and a validity timer of the temporary network slice; and circuitry for sending the information of the temporary network slice and the validity timer of the temporary network slice to a network node.

According to a twentieth aspect there is provided a method comprising: receiving a configuration update, the configuration update comprising information of a temporary network slice and a validity timer of the temporary network slice; and circuitry for sending the information of the temporary network slice and the validity timer of the temporary network slice to a network node.

According to some examples, the configuration update is received via OAM.

According to some examples the method further comprises sending the information of the temporary network slice and the validity timer of the temporary network slice to a network node which comprises sending to core network via a RAN configuration update procedure or NG setup procedure.

According to some examples, the method comprises removing the temporary network slice from a list of supported network slices when the validity timer expires.

According to some examples, the method comprises updating the validity timer of the temporary network slice prior to the validity timer expiring.

According to some examples, the method is performed by an apparatus, wherein the apparatus comprises a radio access network node, and the network node comprises an access and mobility management function.

According to a twenty-first aspect there is provided a computer program comprising instructions for causing an apparatus to perform at least the following: receiving a configuration update, the configuration update comprising information of a temporary network slice and a validity timer of the temporary network slice; and sending the information of the temporary network slice and the validity timer of the temporary network slice to a network node.

According to a twenty-second aspect there is provided a computer program comprising instructions stored thereon for performing at least the following: receiving a configuration update, the configuration update comprising information of a temporary network slice and a validity timer of the temporary network slice; and sending the information of the temporary network slice and the validity timer of the temporary network slice to a network node.

According to a twenty-third aspect there is provided a non-transitory computer readable medium comprising program instructions for causing an apparatus to perform at least the following: receiving a configuration update, the configuration update comprising information of a temporary network slice and a validity timer of the temporary network slice; and sending the information of the temporary network slice and the validity timer of the temporary network slice to a network node.

According to a twenty-fourth aspect there is provided a non-transitory computer readable medium comprising program instructions stored thereon for performing at least the following: receiving a configuration update, the configuration update comprising information of a temporary network slice and a validity timer of the temporary network slice; and sending the information of the temporary network slice and the validity timer of the temporary network slice to a network node.

According to a twenty-fifth aspect there is provided an apparatus comprising means for performing: receiving information from a network node indicating that a validity timer of a temporary network slice has expired; and in response, causing a packet data unit session associated with the temporary network slice to be removed from a user equipment that was using the temporary network slice.

According to some examples, the user equipment comprises a connected user equipment and the causing the packet data unit session to be removed comprises sending a packet data unit session release message.

According to some examples, the causing a packet data unit session to be removed comprises allowing the user equipment to finish the packet data unit session associated with the temporary network slice but not to allow a new packet data unit session associated with the temporary network slice to be started.

According to some examples, the apparatus comprises a session management function.

According to some examples, the means comprises at least one processor; and at least one memory including computer program code, the at least one memory and computer program code configured to, with the at least one processor, cause the performance of the apparatus.

According to a twenty-sixth aspect there is provided an apparatus comprising at least one processor; and at least one memory including computer program code; the at least one memory and the computer program code configured to, with the at least one processor, cause the apparatus at least to perform: receiving information from a network node indicating that a validity timer of a temporary network slice has expired; and in response, causing a packet data unit session associated with the temporary network slice to be removed from a user equipment that was using the temporary network slice.

According to a twenty-seventh aspect there is provided an apparatus comprising: circuitry for receiving information from a network node indicating that a validity timer of a temporary network slice has expired; and in response, circuitry for causing a packet data unit session associated with the temporary network slice to be removed from a user equipment that was using the temporary network slice.

According to a twenty-eighth aspect there is provided a method comprising: receiving information from a network node indicating that a validity timer of a temporary network slice has expired; and in response, causing a packet data unit session associated with the temporary network slice to be removed from a user equipment that was using the temporary network slice.

According to some examples, the method is performed by the user equipment, the user equipment comprises a connected user equipment and the causing the packet data unit session to be removed comprises sending a packet data unit session release message.

According to some examples, the method comprises causing a packet data unit session to be removed, which comprises allowing the user equipment to finish the packet data unit session associated with the temporary network slice but not to allow a new packet data unit session associated with the temporary network slice to be started.

According to some examples, the method is performed by an apparatus, wherein the apparatus comprises a session management function.

According to a twenty-ninth aspect there is provided a computer program comprising instructions for causing an apparatus to perform at least the following: receiving information from a network node indicating that a validity timer of a temporary network slice has expired; and in response, causing a packet data unit session associated with the temporary network slice to be removed from a user equipment that was using the temporary network slice.

According to a thirtieth aspect there is provided a computer program comprising instructions stored thereon for performing at least the following: receiving information from a network node indicating that a validity timer of a temporary network slice has expired; and in response, causing a packet data unit session associated with the temporary network slice to be removed from a user equipment that was using the temporary network slice.

According to a thirty-first aspect there is provided a non-transitory computer readable medium comprising program instructions for causing an apparatus to perform at least the following: receiving information from a network node indicating that a validity timer of a temporary network slice has expired; and in response, causing a packet data unit session associated with the temporary network slice to be removed from a user equipment that was using the temporary network slice.

According to a thirty-second aspect there is provided a non-transitory computer readable medium comprising program instructions stored thereon for performing at least the following: receiving information from a network node indicating that a validity timer of a temporary network slice has expired; and in response, causing a packet data unit session associated with the temporary network slice to be removed from a user equipment that was using the temporary network slice.

### BRIEF DESCRIPTION OF DRAWINGS

Some aspects will now be described in further detail, by way of example only, with reference to the following examples and accompanying drawings, in which:

FIG. 1 illustrates a schematic example of a communication system;

FIG. 2 shows a format of an S-NSSAI;

FIG. 3 shows an example of slice support information exchange;

FIG. 4 shows an example of 5G connection management and UE states;

FIG. 5 shows example deployment for uniform slice support and non- uniform slice-support;

FIG. 6 schematically illustrates non-uniform lice deployment;

FIG. 7 shows a signaling diagram for a UE registration update according to an example;

FIG. 8 shows a signaling diagram for a UE configuration update according to an example;

FIG. 9 shows a signaling diagram for a UE configuration update according to an example;

FIG. 10 schematically shows a user equipment according to an example;

FIG. 11 schematically shows a control apparatus according to an example;

FIGS. 14 to 17 schematically show flow charts of methods according to some examples;

FIG. 18 shows a schematic representation of non-volatile memory media.

### DETAILED DESCRIPTION OF EXAMPLES

The following description gives an exemplifying description of some possibilities and useful background information to practise the invention. Although the specification may refer to “an”, “one”, or “some” examples or embodiment(s) in several locations of the text, this does not necessarily mean that each reference is made to the same example of embodiment(s), or that a particular feature only applies to a single example or embodiment. Single features of different examples and embodiments may also be combined to provide other embodiments.

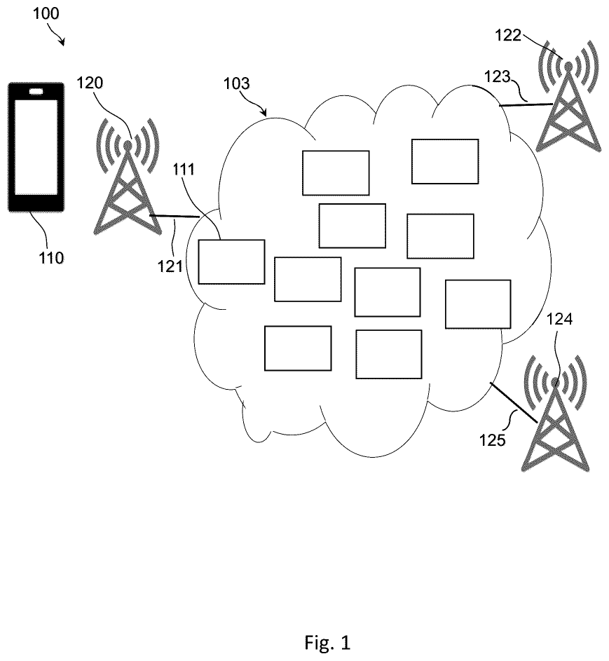

An overall description of an example for a communication system is given first as background with reference to FIG. 1 where a schematic presentation of system 100 comprising radio access systems 120, 122, 124 (radio access network; RAN) and a core network (CN) system shown as cloud 103 are given. A transport system for connecting the core and the respective RAN is denoted by respective lines 121, 123 and 125. A communications device 110 can be located in the service area of one of the radio access systems and can thus communicate wirelessly with the access point provided by the system 120. The access system 120 connects the device to the core network 103. The access system 120 may or may not be operated by a network operator the device 110 subscribes to. A large number of systems provided by a number of different operators can be comprised in the system. The technical specifications, features and capabilities of the different systems can vary substantially.

In FIG. 1 example the radio access systems 120, 122 and 124 are schematically presented by a base station. However, it is noted that a radio access system can comprise a plurality of access points. An access point can comprise any node that can transmit/receive radio signals (e.g., a TRP, a base station such as gNB, eNB, a user device such as a UE and so forth). An example of wireless access architecture is 3GPP 5G radio access architecture. The communication device may access to the Core Network via NG RAN (possibly including satellite access) or via other technologies like Untrusted Non 3GPP access to 5G core (using e.g. a N3IWF), Trusted Non 3GPP access to 5G core (using e.g. a TNGF/TWIF) or Wireline Access (using e.g. a W-AGF or AGF). However, embodiments are not limited to such an architecture.

The communications device 110 is an example of a user which can request for one or more services provided by service providers through the core network 103. The device can be associated with a unique user identity. The user identity may be assigned to the device, to a user of the device or a subscription by a user of the device to a network operator. The device 110 may be any suitable communications device adapted for wireless communications. Non-limiting examples comprise a mobile station (MS) (e.g., a mobile device such as a mobile phone or what is known as a ‘smart phone’), a computer provided with a wireless interface card or other wireless interface facility (e.g., USB dongle), personal data assistant (PDA) or a tablet provided with wireless communication capabilities, machine-type communications (MTC) devices, Internet of Things (IoT) type communications devices or any combinations of these or the like. The device may be provided as part of another device. The device 110 may receive signals over an air or radio interface via appropriate apparatus for receiving and may transmit signals via appropriate apparatus for transmitting radio signals. The communications can occur via multiple paths. Multiple input multiple output (MIMO) type communications may be provided with multiantenna elements.

Services can be provided to the user device by means of one or more sliced networks, e.g., using resources leased by mobile operators from the owner of the underlying telecommunication infrastructure.

The wider communication system, or core network (CN) 103 can comprise a 5G core network (5GC) and entities providing one or more interconnected network functions (NF). The system can comprise one or more data networks (DN). In FIG. 1 blocks 111 denote various possible network functions. The non-exhaustive list of these include an access and mobility management function (AMF), a session management function (SMF), a local PDU session anchor user plane function (L-PSA UPF), a policy control function (PCF), an application function (AF), a network repository function (NRF), and a local NEF (L-NEF). Other management, control and application functions are also possible. For example, entities providing an edge application server (EAS), a unified data management (UDM), a unified data repository (UDR), a network slice selection function (NSSF), and various user plane functions may be provided. A plurality of content providers can also be provided. It shall be appreciated that at least some of the entities denoted by blocks 111 can be provided as virtual data processing instances in virtualized environment.

As discussed briefly above, network slicing is a key 5G feature to support different services using the same underlying mobile network infrastructure [3GPP TS 38.300]. Network slices can differ either in their service requirements like Ultra-Reliable Low Latency Communication (URLLC) and enhanced Mobile Broadband (eMBB), or the tenant that provides those services.

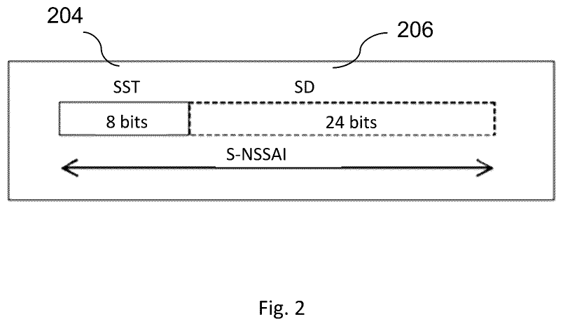

As shown in FIG. 2, a network slice is uniquely identified via the S-NSSAI (Single-Network Slice Selection Assistance Information), schematically shown at 202. Current 3GPP specifications allow a UE to be simultaneously connected and served by at most eight slices that correspond to eight S-NSSAIs [3GPP TS 38.300]. On the other hand, each cell may support tens or even hundreds of slices, e.g., in the current specifications a tracking area can support up to 1024 network slices [3GPP TS 38.423].

The S-NSSAI may include both Slice Service Type (SST) 204 and Slice Differentiator (SD) field 206 with a total length of 32 bits, or include only SST field part in which case the length of S-NSSAI is 8 bits only.

The SST field 204 may have standardized and non-standardized values. Values 0 to 127 belong to the standardized SST range. For instance, SST value of 1 may indicate that the slice is suitable for handling of 5G eMBB, 2 for handling of URLLC, etc. SD field 206 is operator-defined only.

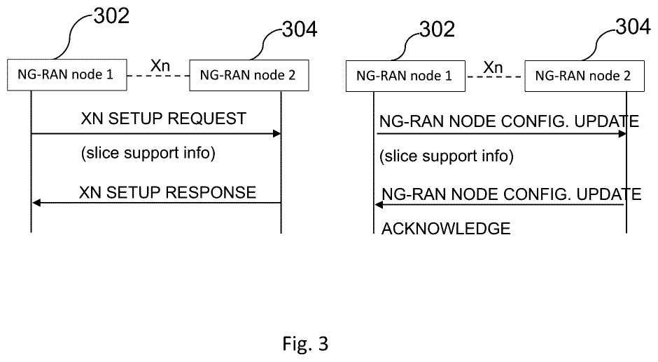

Moreover, and as shown schematically in FIG. 3, in the current specifications, neighbouring gNBs 302 and 304 exchange slice support information per TA over the Xn interface during Xn Set-Up and NG-RAN Node Configuration Update procedures.

A registration area (RA) is a list of Tracking Areas (TAs) for a UE. When a UE registers to the network it can indicate the slices to which it might need access (requested S-NSSAIs). The core network analyses the UE profile and subscription data to verify the list of slices the UE can have access to. As a result, the core network sends a list of “allowed slices” (allowed NSSAI) to the UE. In some examples the list of allowed slices could be different, or only a subset, of the requested slices from the UE request in the registration process. The reason could be that the UE does not have access to a specific slice, or the slice is not supported in the current location (TA) in which the registration request was initiated. If the allowed slices contain at least one slice then the core network also configures a “Registration Area” for that UE. This registration area contains a list of TAs in which all the allowed slices of the UE are supported. The core network knows the current TA of the UE from registration request and may know the slice support of the neighbouring TAs. The core network can configure the list of TAs for the UE in which the slice support can be homogenous for the requesting UE according to the current specifications. Once the UE goes outside of the TAs in the Registration Area, it needs to perform a Registration Area Update, and the core network re-evaluates the UE requested slices to configure a new registration area (see 3GPP TS 23.501).

It should be noted that the core network knows the location of an idle UE in RM-REGISTERED state in terms of an RA. Thus, in case of a network-originated service request (corresponding to mobile terminated-MT service), the AMF pages the gNBs belonging to the TAs of the RA. AMF can apply different paging policies, e.g., page only part of the RA considering the last TA where the UE made the RA update. Thus, there is a trade-off between the size of the RA and paging overhead versus RA update frequency. In other words, large RA implies fewer RA updates but more paging signalling, whereas small RA implies more RA updates but less paging signalling. In addition, with smaller RA, the UE could be reached faster and thus might be preferred for certain services with delay constraints. It is therefore likely that a UE belonging to a network slice(s) with very large coverage areas might be configured with a RA that does not include all the TAs in which the slice is supported, but only a limited set of TAs based on the current TA of the UE.

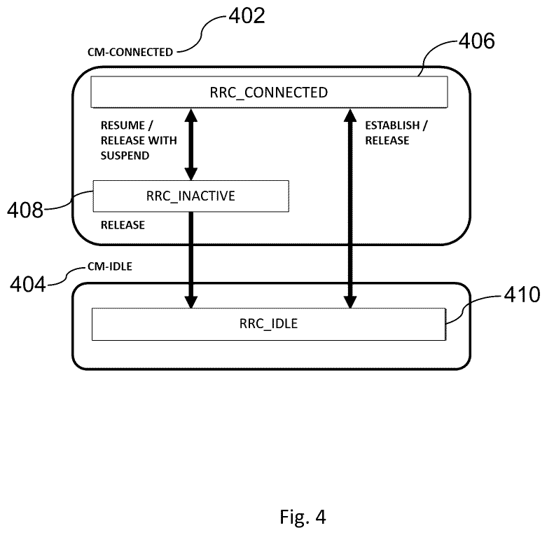

In the current specifications, as shown in FIG. 4, 5G allows two connection management states: CM-CONNECTED 402 and CM-IDLE 404. RRC states RRC_CONNECTED 406 and RRC_INACTIVE 408 belong to the CM-CONNECTED state 402, while RRC_IDLE 410 is part of the CM-IDLE state 404. There is an inherent benefit of having a UE being kept in CM-CONNECTED state when there is no data being transmitted, as both the UE and gNB keep necessary configurations and information exchanged. This can reduce signalling towards core network significantly, as well as allow a UE to have very little delay incurred when it needs to transmit/receive data. These are enhancements that were introduced with 5G, with the “dormant” state referred to RRC_INACTIVE state (see 3GPP TS 38.300). While the UE is in RRC_INACTIVE state, the corresponding UE context is kept within RAN by the last serving gNB. The UE can move within an area configured by RAN, i.e., RAN-based notification area (RNA), without notifying RAN. The RNA can cover a single or multiple cells, and shall be contained within the core network (CN) registration area (see 3GPP TS 38.300).

RRC_INACTIVE is a state where a UE remains in CM-CONNECTED and can move within an area configured by NG-RAN (the RNA) without notifying NG-RAN. In RRC_INACTIVE, the last serving gNB node keeps the UE context and the UE-associated NG connection with the serving AMF and UPF. A UE in the RRC INACTIVE state is required to initiate RNA update procedure when it moves out of the configured RNA.

A UE in the RRC_INACTIVE state can be configured by the last serving NG-RAN node with an RNA, where:
the RNA can cover a single or multiple cells, and shall be contained within the CN registration area; in this release Xn connectivity should be available within the RNA;
a RAN-based notification area update (RNAU) is periodically sent by the UE and is also sent when the cell reselection procedure of the UE selects a cell that does not belong to the configured RNA.

There are several different alternatives on how the RNA can be configured:
List of cells:
A UE is provided an explicit list of cells (one or more) that constitute the RNA.
List of RAN areas:
A UE is provided (at least one) RAN area ID, where a RAN area is a subset of a CN Tracking Area or equal to a CN Tracking Area. A RAN area is specified by one RAN area ID, which consists of a TAC and optionally a RAN area Code;
A cell broadcasts one or more RAN area IDs in the system information.

NG-RAN may provide different RNA definitions to different UEs but not mix different definitions to the same UE at the same time. UE shall support all RNA configuration options listed above.

At any time, the AMF may provide the UE with a new Configured NSSAI for the Serving PLMN, associated with mapping of the Configured NSSAI to HPLMN S-NSSAIs as specified in clause 5.15.4.1 of 3GPP TS 23.501. The AMF provides an updated Configured NSSAI as specified in 3GPP TS 23.502, clause 4.2.4 UE Configuration Update procedure.

Updates to the Allowed NSSAI and/or, if present, to the associated mapping of the Allowed NSSAI to HPLMN S-NSSAIs are also possible if the configuration update affects S-NSSAI(s) in the current Allowed NSSAI.

A UE for which the Configured NSSAI for the Serving PLMN has been updated as described in clause 5.15.4.1 of 3GPP TS 23.501 and has been requested to perform a Registration procedure, shall initiate a Registration procedure to receive a new valid Allowed NSSAI (see clause 5.15.5.2.2 of 3GPP TS 23.501).

The AMF, when it receives the indication from the UDM subscription has changed, indicates the UE that subscription has changed and uses any updated subscription information from the UDM to update the UE. If the UE is in a CM-IDLE state, the AMF may trigger Network Triggered Service Request or wait until the UE is in a CM-CONNECTED state as described in clause 4.2.4.2, 3GPP TS 23.502.

It is identified in the present application that it may be desirable to dynamically set up some slices in certain hot spots (e.g. cells). That is, some network slices (NS) may be temporarily available or unavailable on a periodic basis. For example, one or more network slices can be added (and subsequently removed) to meet a need for a certain period of time. For these dynamic network slices the system would require resource consuming updates of the configuration when the NS becomes available. These updates may include overall network interfaces (NG, Xn) and also the UE and AMF configurations, as well as UDM. The present disclosure is directed towards improvements in dealing with such dynamic slices.

As will be discussed in more detail below, a concept of the present disclosure is to associate the S-NSSAI of a temporarily available network slice (i.e. a dynamic network slice) with timing information that indicates timing information of the network slice availability. In some examples the timing information comprises a time interval. In some examples the timing information comprises an absolute time interval. In some examples the absolute time interval is relative to a known time reference (e.g. a standardized time reference). In some examples the timing information comprises a periodicity. In some examples the periodicity starts from an absolute time.

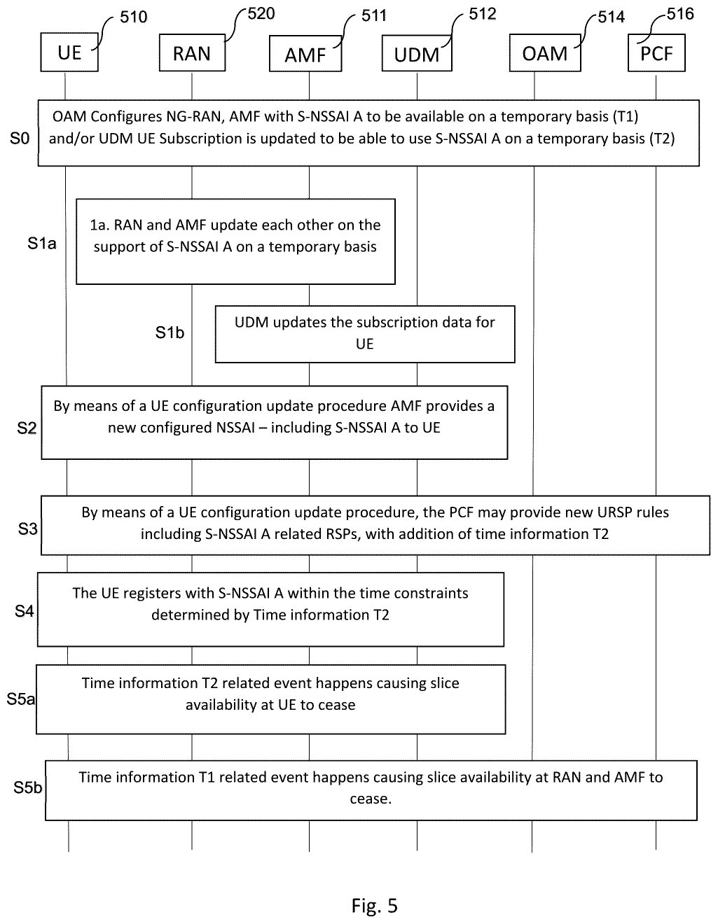

An example will now be described with reference to FIG. 5, which schematically shows communication between a UE 510, RAN 520, AMF 511, UDM 512, OAM (Operations, Administration and Maintenance) 514, and PCF 516. In this example, and for ease of explanation, one temporary network slice is referred to (S-NSSAI A). It will be understood that in practice there may be more than one temporary network slice (S-NSSAI B, S-NSSAI C etc.), and the disclosure extends to such situations.

As shown, at S0, OAM configures NG-RAN and AMF with deployed network slice A (S-NSSAI A), which may also be referred to as S-NSSAI A. This may be considered a dynamic network slice. In examples, the S-NSSAI A is configured to be available on a temporary basis. For example the S-NSSAI A may be available for a time T1. This time may be considered time information. In some examples, UDM UE subscription is updated to be able to use S-NSSAI A on a temporary basis for time information T2. It should be noted that T1 and T2 may or may not be the same. In some examples, PCF 516 is given rules with time information for the UE. For example, PCF 516 may be given time information T1 and/or T2 associated with network slice S-NSSAI A.

In examples, T1 is the value based on network configuration via OAM, while T2 may be based on UE subscription. For example and for the purpose of explanation, there can be a temporary slice that is available for weekend games in a stadium (i.e. for 48 hrs). To support this deployment RAN/AMF are configured to support this temp slice for 48 hrs (T1). On the other hand, the UE may subscribe to this service for an amount of time (T2). According to some examples, T1 may be considered a first validity timer which comprises a deployment time of the network slice. According to some examples, T2 may be considered a second validity timer which comprises a time for which the apparatus is allowed to use the network slice (e.g. based on subscription).

At Sia, RAN 520 and AMF 511 update each other on the support of S-NSSAI A on a temporary basis for time information T1. For example this may be achieved using NG-AP (3GPP TS 38.413) messages. In some examples, RAN 520 and AMF 511 communicate the timing information T1 for applicable S-NSSAI A.

At S1b, the UDM 512 updates subscription data for UE 510. The timing information T2 is stored as part of the updated subscription data, for the applicable S-NSSAI A. As noted above, T2 may be different to or the same as T1.

At S2, by means of a UE configuration update procedure, or by registration accept if the registration happens earlier than AMF can send the configuration update, the AMF 511 provides a new configured NSSAI (including S-NSSAI A) to UE 510. As part of this configuration update, AMF 511 provides UE 510 with the time information T2 for S-NSSAI A.

At S3, by means of a UE configuration update procedure, the PCF 516 may provide new URSP (UE route selection policy), including S-NSSAI A related RSPs (route selection policies) to UE 510, including time information T2. UE parameters update procedure is used when any update in UE parameters at the UDM is to be updated at the UE via NAS signalling. (See TS 23.502—section 4.20). This mechanism may be used in this scenario. UE Configuration update procedure is used by the PCF to update UE policies (see TS 23.502, section 4.2.4.3).

At S4, UE 510 registers with S-NSSAI A, with time constraints determined by time information T2. UE 510 then starts using connectivity in S-NSSAI A for PDU session establishment procedure as per the URSP rules.

In this example, at S5a time information T2 related event occurs. For example, this event may cause slice availability at UE 510 to cease. Then, the NSSAI allowed by UE 510 locally changes (i.e. at UE 510) to exclude S-NSSAI A. In examples, the network also updates its allowed NSSAI to exclude S-NSSAI A. Furthermore, the network may release any connectivity associated with S-NSSAI A. In examples, the UE 510 may then register again (as per S2), if T2 is of a periodic nature. Otherwise, no more information is retained at UE 510 or AMF 511 related to S-NSSAI A.

In this example, at S5b a time information T1 related event occurs. This event causes slice availability at RAN 520 and AMF 511 to cease. In examples, the information of supported slices at AMF 511 and RAN 520 automatically updates, and there is no need for further NG exchange. In examples, if T1 is periodic then this is updated to support S-NSSAI A again later on. Depending on the situation (e.g. if T1 is not provided to UE also by means of T2), the UE 510 may need to get an updated allowed NSSAI.

It is to be noted that the temporal availability of S-NSSAI A may apply differently for the network and the UE. The slice S-NSSAI A may, for example, be permanently deployed but only temporarily available for the UE 510. Or, the time for deployment T1 and availability at UE T2 may differ. It is to be noted that in examples T1 fully encompasses T2 i.e. T1>T2.

It will also be noted that the network may or may not inform the UE 510 explicitly of T1 by means of T2. For example, this enables temporary deployments to operate also with legacy UEs, where the network can be upgraded to support time awareness optimizations.

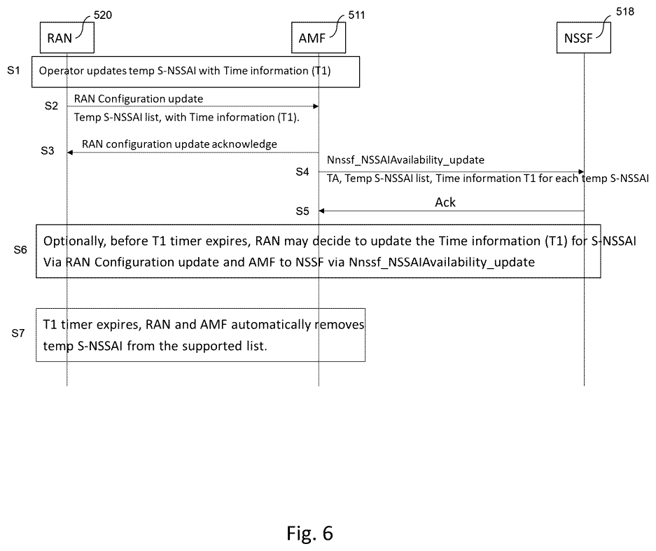

Network configuration of the temporary slice (e.g. S-NSSAI A) validity timer will now be discussed with respect to FIG. 6, which shows communication between RAN 520, an AMF 511, and network slice selection function (NSSF) 518.

As shown, at S1 operator updates temp S-NSSAI with Time information (T1) for the temporary slice.

At S2, there is a RAN Configuration update, including Temp S-NSSAI list, with Time information (T1), sent from RAN 520 to AMF 511.

At S3, there is a RAN configuration update acknowledge message from AMF 511 to RAN 520.

At S4, AMF 511 sends to NSSF 518 Nnssf_NSSAIAvailability_update. In some examples this update includes TA, Temp S-NSSAI list, Time information T1 for each temp S-NSSAI.

At S5, NSSF 518 sends an ACK to AMF 511.

Or, S4 and S5 could be combined as an Nnssf_NSSAIAvailability update service operation, which usually involves NF consumer (AMF in this case) sending PUT request to NSSF and NSSF responding with 200 OK (see TS 23.531, section 5.3.2.2)

At S6, optionally, before T1 timer expires, RAN 520 may decide to update the Time information (T1) for S-NSSAI. In some examples RAN 520 performs this update via RAN Configuration update and AMF to NSSF via Nnssf_NSSAIAvailability_update.

In this example, at S7 the T1 timer expires. RAN 520 and AMF 511 (and indeed NSSF, or any other NF updated with this timing information for the NS) automatically remove temp S-NSSAI from the supported list.

It will be noted that in the example of FIG. 6 it is only show that RAN 520 and AMF 511 update each other on the support of the temporary network slice (e.g. “S-NSSAI A”) according to time info T1, and AMF 511 updates NSSF 518. In deployments where more than one neighbouring gNB support S-NSSAI A, they would also exchange the support of S-NSSAI A over Xn using the same method of adding the timing information in association to the S-NSSAI value “A” of S-NSSAI A. If there is any further update in the Time information T1 before T1 expires, then the value is updated to the latest value.

In examples a network function (NF) may be supporting a temporarily available S-NSSAI according to a timing information provided by OAM. this NF would register this S-NSSAI with the network repository function (NRF) by also including the timing information. The NRF takes the timing information into account and will disassociate a NF from this S-NSSAI consistently with the timing information.

In examples, Xn Set-Up and NG-RAN Node Configuration Update procedures can be utilized, for example. In case of a disaggregated gNB, F1 Set-Up and Node Update procedures (e.g., gNB-DU Configuration Update) can be utilized, for example. In addition, the slice support information can be per cell and/or TA. The slice information can be per slice, e.g., associated with S-NSSAI(s) and/or per slice group, e.g., associated with a slice group ID.

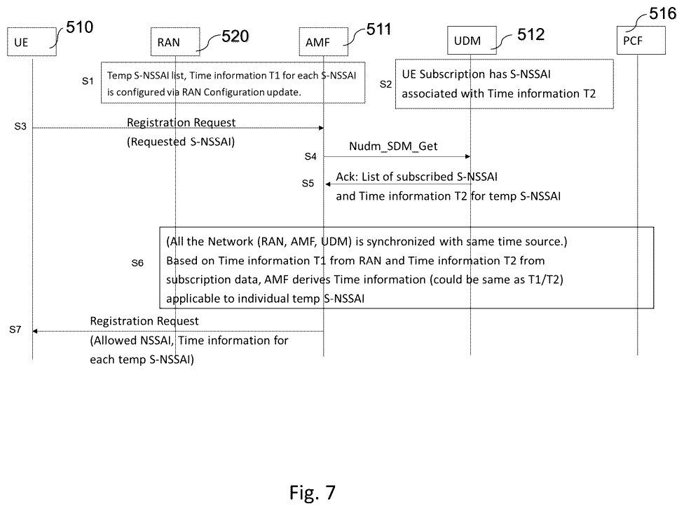

Registration procedure update indicating temporary slice availability will now be described in more detail with respect to FIG. 7, which shows communication between UE 510, RAN 520, AMF 511, UDM 512 and PCF 516.

As shown at S1, Temp S-NSSAI list, Time information T1 for each S-NSSAI is configured via RAN Configuration update between RAN 520 and AMF 511.

As shown at S2, at UDM 512, UE Subscription has S-NSSAI associated with Time information T2.

At S3, a registration request with requested S-NSSAI is sent from UE 510 to RAN 520.

At S4, AMF 511 sends a Nudm_SDM_Get service operation message to UDM 512 (see TS29.503, section 5.2.2.2.2).

At S5, UDM 512 sends an ACK to AMF 511 that includes the list of subscribed S-NSSAI. The message at S5 also includes time information T2 for temp S-NSSAI.

As shown at S6, all the network (e.g. RAN, AMF, UDM) is synchronized with same time source. Based on Time information T1 from RAN and Time information T2 from subscription data, AMF derives time information (could be same as T1/T2) applicable to individual temp S-NSSAI.

As shown at S7, AMF 511 sends a registration request to UE 510. The registration request comprises information of allowed NSSAI, and time information for each temporary S-NSSAI.

It will be noted that the UDM 512 may receive from OAM the subscription information for UE 510 which contains time information T2. T2 may match T1, or differ. The UDM 512 updates the AMF 511 with the updated subscription information including timing information T2 (see S1b of FIG. 5).

This causes the AMF 511 to update also the UE 510 with a configured NSSAI including S-NSSAI A with time information T2 (S2 of FIG. 5), if the UE 510 has indicated that it supports this information handling in UE 5G MM capability in the last received registration message. If not, such timing information is not provided but the UE 510 may still be provided with a configured NSSAI, including also S-NSSAI A (i.e. the dynamically deployed slice).

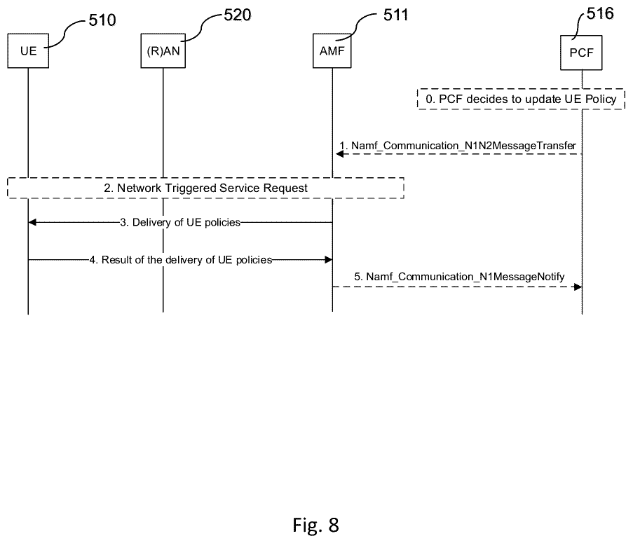

The UE configuration update procedure to update URSP rules with a slice validity timer will now be described in more detail with respect to FIG. 8 which shows communication between UE 510, RAN 520, AMF 511, and PCF 516.

At S0, PCF 516 decides to update UE policy.

At S1, PCF 516 sends to AMF 511 a Namf communication message.

As shown at S2, there is a network triggered service request. In some examples this is required only if UE is in CM Idle mode and not needed for CM-Connected mode UEs.

As shown at S3, UE policy information is sent from AMF 511 to UE 510. This information includes URSP rules update with S-NSSAI and time information.

At S4, UE 510 sends to AMF 511, the result of the delivery of UE policies.

At S5, a Namf communication is sent from AMF 511 to PCF 516 (this procedure is described in TS 23.502, section 4.2.4.3).

It is to be noted that the PCF 516 also updates the URSP rules in the UE 510 and these rules may contain time related information, so they are automatically updated, for example, based on the UE handling instead of explicit network configuration factoring in the timing information provided to the UE by the network.

It will be noted that in S4, the UE 510 can now register with S-NSSAI A and use the services in S-NSSAI A, when it needs to, compatibly with any received T2 information.

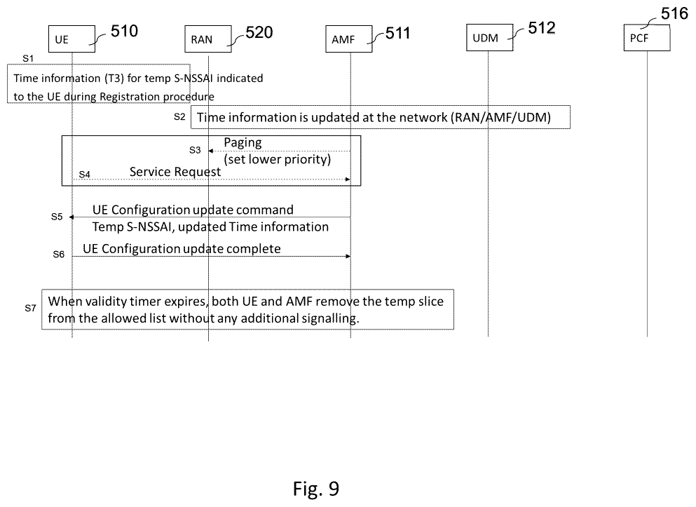

The UE configuration update procedure to update any change in slice validity timer will now be described in more detail with respect to FIG. 9, which shows communication between UE 510, RAN 520, AMF 511, UDM 512 and PCF 516.

As shown at S1, time information for temp S-NSSAI is indicated to the UE during Registration procedure. For the purpose of explanation, the time information at S1 may be considered T3. In examples, T3 could be the same as T1 or T2, and T1 may be the same as or different from T2). By way of explanation:
T1: OAM configured at the network nodes/NF
T2: based on UE subscription stored at UDM
T3: value calculated by AMF based on T1 and T2, and assigned to the UE in registration accept message.

Time information is also updated at the network (e.g. RAN 520, AMF 511, UDM 512), as shown at S2.

At S3, AMF 511 pages RAN 520.

At S4, a service request is sent from UE 510 to AMF 511.

At S5 a UE configuration update command is sent to UE 510 from AMF 511. According to examples, this comprises information of the temporary S-NSSAI and the updated time information, T3.

At S6 a UE configuration update complete message is sent from UE 510 to AMF 511.

At S7, when the validity timer expires, both UE 510 and AMF 511 remove the temporary slice from the allowed list without any additional signalling.

Thus, also with reference back to FIG. 5, it will be noted that when T2 causes the slice to become no longer available as in step 5a, the UE 510 and AMF 511 remove the S-NSSAI A from the allowed NSSAI automatically with no need to exchange further signalling. Likewise, if T2 is of a periodic nature, the configured NSSAI allows the UE 510 to register again when the time period or availability resumes. In examples the URSP rules are also updated accordingly, based on T2.

According to examples, at some point (if applicable) time T1 also may cause the S-NSSAI A to not be available in RAN 520 and AMF 511. If this occurs, the UE gets a new updated configured and allowed NSSAI as needed, if the UE was not itself aware of T1 by means of a matching T2 provided in step 1b.

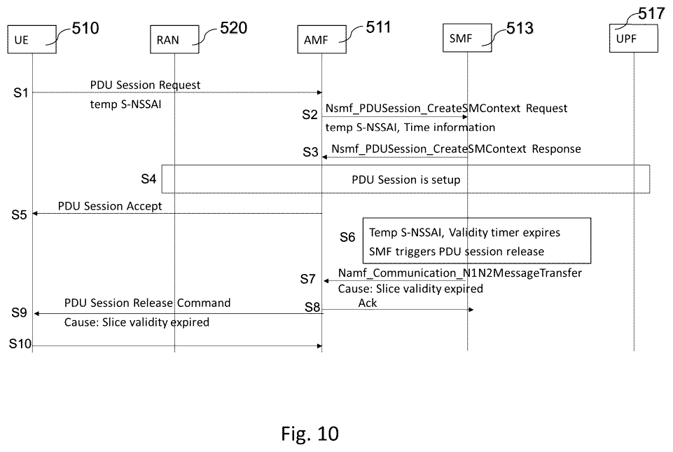

PDU session establishment/release is now described in more detail with respect to FIG. 10, which shows communication between UE 510, RAN 520, AMF 511, SMF 513 and UPF 517.

S1 shows PDU Session Request with temp S-NSSAI sent from UE 510 to RAN 520.

S2 shows PDU session request sent from AMF 511 to SMF 513. This request comprises time information of the temp S-NSSAI.

At S3, PDU session response message is sent from SMF 513 to AMF 511.

At S4, PDU session is setup

At S5, PDU session accept message is sent from AMF 511 to UE 510.

In this example, at S6, the temporary S-NSSAI validity timer expires, and the SMF 513 triggers PDU session release.

At S7, it is communicated from SMF 513 to AMF 511 that the slice validity has expired.

At S8, the AMF 511 sends an acknowledgement to the SMF 513.

At S9, AMF 511 informs UE 510 that the slice validity has expired.

At S10, UE 510 informs AMF 511 that the PDU session release is complete.

Thus it will be noted that, from OAM or AMF, SMF 513 is informed about the time information related to the temporary slice. Therefore, when a PDU session is established for a temporary slice, the SMF is aware of the time information and on expiry of the time information may release the respective PDU session. In an example the SMF may do this with the cause “Slice validity expired” indicating the temporary slice is no longer available.

According to some examples, the causing a packet data unit session to be removed (e.g. S6 in FIG. 10) comprises allowing the user equipment to finish the packet data unit session associated with the temporary network slice but not to allow a new packet data unit session associated with the temporary network slice to be started by the user equipment.

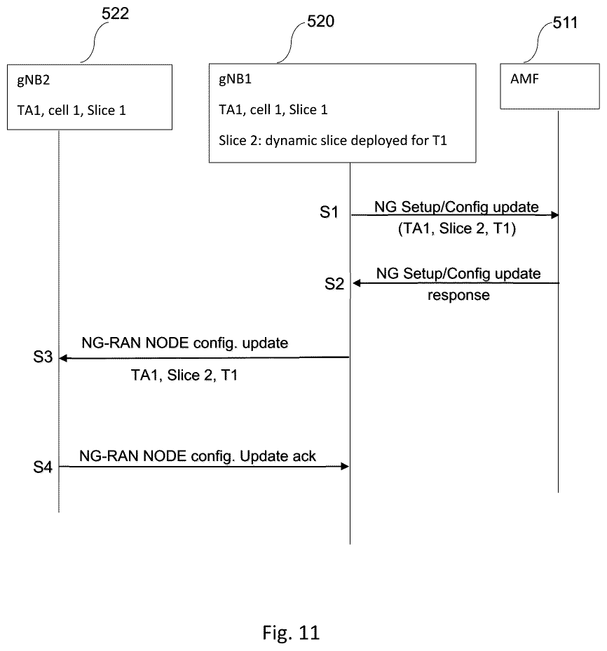

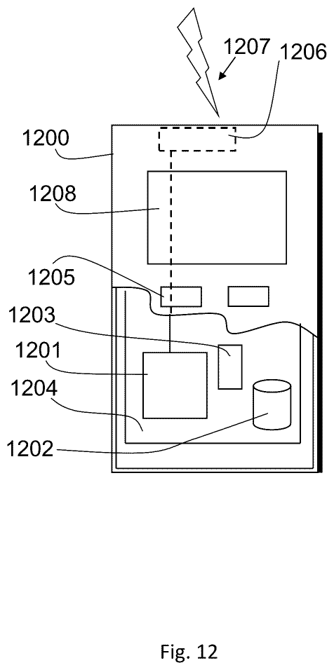

A further embodiment is now described with respect to FIG. 11, which shows communication between a first base station (gNB1) 520, a second base station (gNB2) 522 and AMF 511. As shown, second base station 522 is in TA1, cell 1, slice 1. First base station 520 is also in TA1, cell 1, slice 1, but for base station 520 a dynamic slice (slice 2) is deployed for time T1.

S1 shows NG setup/config update message sent from first base station 520 to AMF 511. This configuration update message comprises information including TA1, and information of slice 2 including the lifetime for slice 2 (T1).

At S2, a setup/configuration update response is sent from AMF 511 to first base station 520.

At S3, a configuration update is sent from first base station 520 to second base station 522. This configuration update includes information of TA1, and slice 2 including the lifetime T1.

At S4 a configuration update acknowledgement message is sent from second base station 522 to first base station 520.

It will be noted that depending on the format of the time information (e.g., absolute value or a timer), the timing information in different procedures may differ, e.g., the timing information during the NGAP procedures and XnAP procedures may be different.

It will also be appreciated from FIG. 11 that slice support information can be coupled with a tracking area, e.g., in case of uniform slice support, or can be coupled with a cell, e.g., in case of non-uniform slice support.

In examples, the network may apply different strategies to efficiently update the UE configurations in case of the dynamic/temporal slices. It will be appreciated that, in case of new deployments of slices in a few cells of a TA which are not uniformly supported across the TA, the UE configuration updates can be substantially reduced, which leads to decreased signaling overhead.

In some examples, the 5GS determines the list of UEs (based on subscription information) that need configuration update to be informed about the updated configured/allowed NSSAI.

Some optimization proposals are also discussed in turn below.
Optimization for UE Configuration Update for CM-Connected UEs, i.e., RRC Connected and RRC Inactive UEs
   Instead of initiating UE configuration update for all the UEs whose registration (RA) includes the updated TA with dynamic slice, 5GC further filters the UEs which are in the TA and/or gNB (where the dynamic slice is deployed), or in the vicinity of the deployed dynamic slice, and performs UE configuration updates. 5GC applies staggered UE Configuration Update, where before UE moves to the TA and/or gNB (where the dynamic slice is deployed), the new configured/allowed NSSAI are provided.for example: gNBs/TAs with dynamic slice and the neighboring gNBs/TAs
   For 5GS, the RRC Inactive UE would still be considered as CM connected state and above procedure applies.
Optimization for UE Configuration Update for CM-Idle UEs, i.e., RRC Idle UEs
   Optimized paging is proposed, where the list of idle UEs that need to be updated about the new configured/allowed NSSAI is identified.
   Further filtration is done, where the last known Cell ID belonging to the TA where the dynamic slice is deployed, is identified for paging.
   Further filtration is done, based on the periodic registration timer, the UEs whose timers were recently started are listed to be paged.
      It is proposed to not page those UEs whose periodic registration timers are about to expire. 5GC can perform the UE configuration update as part of the periodic registration procedure.
   In a further embodiment, AMF shall indicate “lower paging priority” in the paging message and RAN would perform staggered paging for those identified UEs.

A possible wireless communication device will now be described in more detail with reference to FIG. 12 showing a schematic, partially sectioned view of a communication device 1200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. In the present teachings the terms UE or “user” are used to refer to any type of wireless communication device.

The wireless device 1200 may receive signals over an air or radio interface 1207 via appropriate apparatus for receiving and may transmit signals via appropriate apparatus for transmitting radio signals. In FIG. 12 transceiver apparatus is designated schematically by block 1206. The transceiver apparatus 1206 may be provided for example by means of a radio part and associated antenna arrangement. The antenna arrangement may be arranged internally or externally to the wireless device.

A wireless device is typically provided with at least one data processing entity 1201, at least one memory 1202 and other possible components 1203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 1204. The user may control the operation of the wireless device by means of a suitable user interface such as key pad 1205, voice commands, touch sensitive screen or pad, combinations thereof or the like. A display 1208, a speaker and a microphone can be also provided. Furthermore, a wireless communication device may comprise appropriate connectors (either wired or wireless) to other devices and/or for connecting external accessories, for example hands-free equipment, thereto.

FIG. 13 shows an example of a control apparatus for a communication system, for example to be coupled to and/or for controlling a station of an access system, such as a RAN node, e.g. a base station, gNB, a central unit of a cloud architecture or a node of a core network such as an MME or S-GW, a scheduling entity such as a spectrum management entity, or a server or host. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 1300 can be arranged to provide control on communications in the service area of the system. The control apparatus 1300 comprises at least one memory 1301, at least one data processing unit 1302, 1303 and an input/output interface 1304. Via the interface the control apparatus can be coupled to a receiver and a transmitter of the base station. The receiver and/or the transmitter may be implemented as a radio front end or a remote radio head. For example the control apparatus 1300 or processor 1301 can be configured to execute an appropriate software code to provide the control functions.

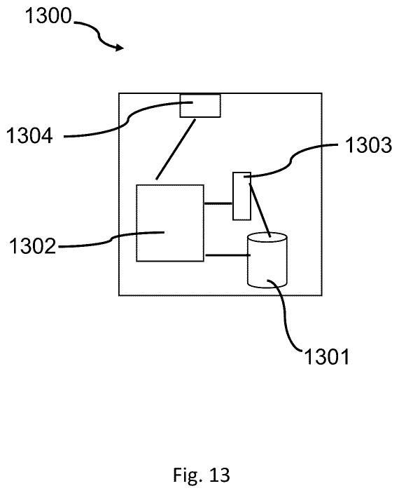

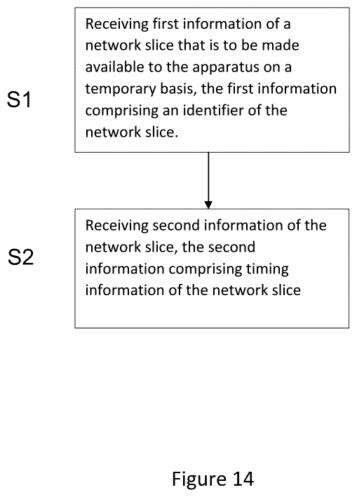

FIG. 14 is a flow chart of a method according to an example. The method of FIG. 14 is viewed from the perspective of an apparatus. For example, the apparatus may comprise a user equipment.

As shown at S1, the method comprises receiving first information of a network slice that is to be made available to the apparatus on a temporary basis, the first information comprising an identifier of the network slice.

As shown at S2, the method comprises receiving second information of the network slice, the second information comprising timing information of the network slice.

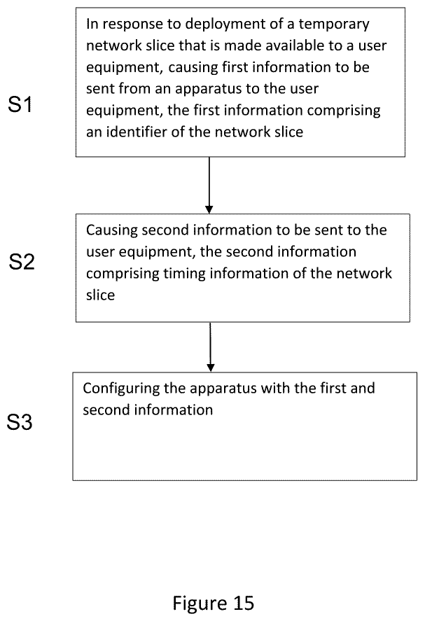

FIG. 15 is a flow chart of a method according to an example. The method of FIG. 15 is viewed from the perspective of an apparatus. For example, the apparatus may comprise an access and mobility management function (AMF).

As shown at S1 the method comprises, in response to deployment of a temporary network slice that is made available to a user equipment, causing first information to be sent from the apparatus to the user equipment, the first information comprising an identifier of the network slice.

As shown at S2, the method comprises causing second information to be sent to the user equipment, the second information comprising timing information of the network slice.

As shown at S3, the method comprises configuring the apparatus with the first and second information.

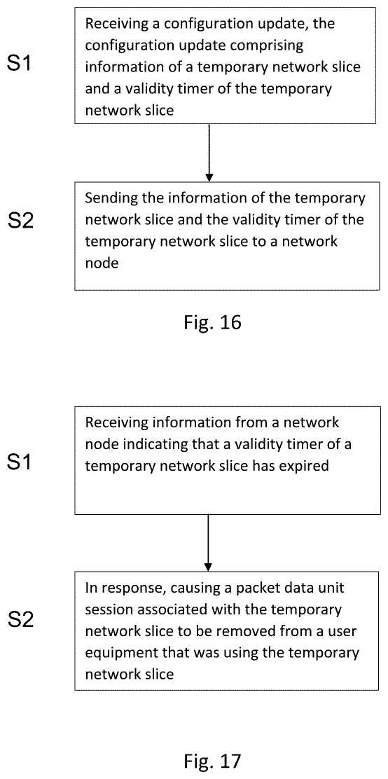

FIG. 16 is a flow chart of a method according to an example. The method of FIG. 16 is viewed from the perspective of an apparatus. For example, the apparatus may comprise a radio access network (RAN) node).

As shown at S1 the method comprises receiving a configuration update, the configuration update comprising information of a temporary network slice and a validity timer of the temporary network slice.

As shown at S2 the method comprises sending the information of the temporary network slice and the validity timer of the temporary network slice to a network node.

FIG. 17 is a flow chart of a method according to an example. The method of FIG. 17 is viewed from the perspective of an apparatus. For example, the apparatus may comprise a session management function (SMF).

As shown at S1, the method comprises receiving information from a network node indicating that a validity timer of a temporary network slice has expired.

As shown at S2, in response, the method comprises causing a packet data unit session associated with the temporary network slice to be removed from a user equipment that was using the temporary network slice.

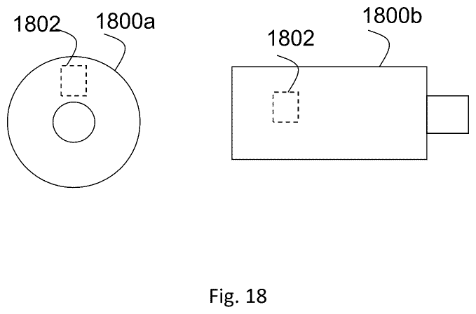

FIG. 18 shows a schematic representation of non-volatile memory media 1800a (e.g. computer disc (CD) or digital versatile disc (DVD)) and 1800b (e.g. universal serial bus (USB) memory stick) storing instructions and/or parameters 1802 which when executed by a processor allow the processor to perform one or more of the steps of the methods of FIGS. 14 to 17. In general, the various embodiments may be implemented in hardware or special purpose circuits, software, logic or any combination thereof. Some aspects of the disclosure may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. At least a part of the functions can be provided in virtualised environment, and at least some of the entities can be provided as virtual computing instances. Further in this regard it should be noted that any of the above procedures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples.

Alternatively or additionally some embodiments may be implemented using circuitry. The circuitry may be configured to perform one or more of the functions and/or method procedures previously described. That circuitry may be provided in the network entity and/or in the communications device and/or a server and/or a device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory (ies) that work together to cause the communications device and/or device and/or server and/or network entity to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

It is noted that whilst embodiments have been described in relation to certain architectures, similar principles can be applied to other systems. Therefore, although certain embodiments were described above by way of example with reference to certain exemplifying architectures for wireless networks, technologies standards, and protocols, the herein described features may be applied to any other suitable forms of systems, architectures and devices than those illustrated and described in detail in the above examples. It is also noted that different combinations of different embodiments are possible. It is also noted herein that while the above describes exemplifying embodiments, there are several variations and modifications which may be made to the disclosed solution without departing from the spirit and scope of the present invention.

1-41. (canceled)

42. A user equipment comprising:
at least one processor; and
at least one memory storing instructions, which when executed by the at least one processor, cause the user equipment at least to perform:
receiving first information of a network slice that is to be made available to the user equipment on a temporary basis, the first information comprising an identifier of the network slice;
receiving second information of the network slice, the second information comprising timing information indicating time of availability of the network slice; and
accessing the network slice in accordance with the timing information indicating the time of availability of the network slice.

43. The user equipment according to claim 42, wherein the first information comprises single network slice selection assistance information.

44. The user equipment according to claim 42, wherein the timing information comprises a validity time of the network slice.

45. The user equipment according to claim 44, wherein the validity time is in the form of at least one of:
an absolute time interval;
a time interval relative to a reference time; or
a periodic time interval.

46. The user equipment according to claim 44, wherein the instructions, when executed by the at least one processor, further cause the user equipment to perform:
automatically considering the network slice as rejected when the validity time expires.

47. The user equipment according to claim 44, wherein the instructions, when executed by the at least one processor, further cause the user equipment to perform:
stopping a packet data unit session when the validity time expires.

48. The user equipment according to claim 44, wherein the instructions, when executed by the at least one processor, further cause the user equipment to perform:
when the validity time expires,
enabling any ongoing packet data unit sessions associated with the network slice to be completed; and
preventing any new packet data unit sessions associated with the network slice from being started.

49. The user equipment according to claim 42, wherein the timing information comprises at least one of:
a first validity time comprising a deployment time of the network slice; or
a second validity time comprising a time for which the apparatus is allowed to use the network slice.

50. A non-transitory computer readable medium comprising instructions that, when executed by at least one processor, cause a user equipment to perform at least the following:
receiving first information of a network slice that is to be made available to the user equipment on a temporary basis, the first information comprising an identifier of the network slice;
receiving second information of the network slice, the second information comprising timing information indicating time of availability of the network slice; and
accessing the network slice in accordance with the timing information indicating the time of availability of the network slice.

51. The non-transitory computer readable medium according to claim 50, wherein the first information comprises single network slice selection assistance information.

52. The non-transitory computer readable medium according to claim 50, wherein the timing information comprises a validity time of the network slice.

53. The non-transitory computer readable medium according to claim 52, wherein the validity time is in the form of at least one of:
an absolute time interval;
a time interval relative to a reference time; or
a periodic time interval.

54. The non-transitory computer readable medium according to claim 52, wherein the instructions, when executed by the at least one processor, further cause the user equipment to perform at least the following:
automatically considering the network slice as rejected when the validity time expires.

55. The non-transitory computer readable medium according to claim 52, wherein the instructions, when executed by the at least one processor, further cause the user equipment to perform at least the following:
stopping a packet data unit session when the validity time expires.

56. The non-transitory computer readable medium according to claim 52, wherein the instructions, when executed by the at least one processor, further cause the user equipment to perform at least the following:
enabling any ongoing packet data unit sessions associated with the network slice to be completed; and
preventing any new packet data unit sessions associated with the network slice from being started.

57. The non-transitory computer readable medium according to claim 50, wherein the timing information comprises at least one of:
a first validity time comprising a deployment time of the network slice; or
a second validity time comprising a time for which the apparatus is allowed to use the network slice.

58. A method of a user equipment, the method comprising:
receiving first information of a network slice that is to be made available to the user equipment on a temporary basis, the first information comprising an identifier of the network slice;
receiving second information of the network slice, the second information comprising timing information indicating time of availability of the network slice; and
accessing the network slice in accordance with the timing information indicating the time of availability of the network slice.

59. The user equipment according to claim 52, wherein the first information comprises single network slice selection assistance information.

60. The non-transitory computer readable medium according to claim 52, wherein the timing information comprises a validity time in the form of at least one of:
an absolute time interval;
a time interval relative to a reference time; or
a periodic time interval.

61. The user equipment according to claim 52, wherein the timing information comprises at least one of:
a first validity time comprising a deployment time of the network slice; or
a second validity time comprising a time for which the apparatus is allowed to use the network slice.
